(19) United States
(12) Patent Application Publication
(10) Pub. No.: US 2005/0173247 A1
(43) Pub. Date: Aug. 11, 2005

(54) Microtiter plate format device and methods for separating differently charged molecules using an electric field

(75) Inventors: Shila Jalali, San Diego, CA (US); Karla Ewalt, San Diego, CA (US); Paul Swanson, Santee, CA (US); Brian Dwyer, San Diego, CA (US); Michael J. Heller, Encinitas, CA (US); John R. Havens, San Diego, CA (US); Eugene Tu, San Diego, CA (US)

Correspondence Address: MORGAN LEWIS & BOCKIUS LLP, 1111 PENNSYLVANIA AVENUE NW, WASHINGTON, DC, 20004, US

(73) Assignee: Nanogen, Inc.

(21) Appl. No.: 10/980,821

(22) Filed: Nov. 4, 2004

Related U.S. Application Data
(62) Division of application No. 09/724,836, filed on Nov. 28, 2000.

(51) Int. Cl. G01N 27/453

(52) U.S. Cl. 204/450; 204/600

(57) ABSTRACT

The present invention relates generally to microtiter plate format devices and methods for separating molecules having different net charges. The devices and methods of the invention are particularly suited for use in high-throughput screening to monitor enzymatic reactions which result in a product having an altered net charge. For example, the systems and methods disclosed herein may be used to detect the activity of phosphatases, proteases and kinases on various peptidic substrates under various conditions.

### FIELD OF INVENTION

The present invention relates generally to microtiter plate format devices and methods for separating molecules having different net charges. The devices and methods of the invention are particularly suited for use in high-throughput screening to monitor enzymatic reactions which result in a product having an altered net charge. For example, the systems and methods disclosed herein may be used to detect the activity of phosphatases, proteases and kinases on various peptidic substrates under various conditions.

### BACKGROUND OF THE INVENTION

Protein kinases are of particular interest in drug discovery research because they have been shown to be key regulators of many cell functions, including signal transduction (Ullrich and Schlessinger, 1990), transcriptional regulation (Pawson and Bernstein, 1990), cell motility (Miglietta and Nelson, 1988) and cell division (Pines and Hunter, 1990). Protein kinases are enzymes which covalently modify proteins and peptides by the attachment of a phosphate group to one or more sites on the protein. Phosphatases perform the opposite function. Many of the known protein kinases use adenosine triphosphate (ATP) as the phosphate donor, placing the y-phosphate onto a histidine, tyrosine, serine or threonine residue in the protein. The location of the modification site and the type of residue modified by the kinase are usually specific for each particular kinase.

The added phosphate alters certain structural, thermodynamic and kinetic properties of the phosphorylated protein. Generally, the phosphate adds two negative charges to the protein. This modifies the electrostatic interactions between the protein's constituent amino acids, in turn altering secondary and tertiary protein structure. The phosphate may also form up to three hydrogen bonds or salt bridges with other protein residues, or may otherwise change the conformational equilibrium between different functional states of the protein. These structural changes provide the basis, in a biological system, for altering substrate binding and catalytic activity of the phosphorylated proteins.

Phosphorylation and dephosphorylation reactions, under the control of kinases and phosphatases, respectively, can occur rapidly to form stable structures. This makes the phosphorylation system ideal as a regulatory process. Phosphorylation and dephosphorylation reactions may also be part of a cascade of reactions that can amplify a signal that has an extracellular origin, such as hormones and growth factors.

Methods for assaying the activity of protein kinases often utilize a synthetic peptide substrate that can be phosphorylated by the kinase protein under study. The most common mechanisms for detecting phosphorylation of the peptide substrates are 1) Incorporation of ³²P (or ³³P) phosphate from [³²P]γ-ATP into the peptides, purification of the peptides from ATP, and scintillation or Cherenkov counting of the incorporated radionucleotide, 2) Detection of phosphoamino acids with radiolabeled specific antibodies, or 3) Purification of phosphorylated peptides from unphosphorylated peptides by chromatographic or electrophoretic methods, followed by quantification of the purified product.

For example, in one widely used method, a sample containing the kinase of interest is incubated with activators and a substrate in the presence of gamma ³²P-ATP, with an inexpensive substrate, such as histone or casein, being used. After a suitable incubation period, the reaction is stopped and an aliquot of the reaction mixture is placed directly onto a filter that binds the substrate. The filter is then washed several times to remove excess radioactivity, and the amount of radiolabelled phosphate incorporated into the substrate is measured by scintillation counting (Roskoski, 1983).

The use of ³²P in assays, however, poses significant disadvantages. One major problem is that, for sensitive detection, relatively high quantities of ³²P must be used routinely and subsequently disposed. The amount of liquid generated from the washings is not small, and contains ³²P. Due to government restrictions, this waste cannot be disposed of easily. It must be allowed to decay, usually for at least six months, before disposal. Another disadvantage is the hazard posed to personnel working with the isotope. Shielding and special waste containers are inconvenient but necessary for safe handling of the isotope. Further, the lower detection limit of the assay is determined by the level of background phosphorylation and is therefore variable. Although radioisotope methods have been applied in high throughput screening, the high cost and strict safety regulation incurred with the use of radioisotopes in high throughput screening greatly limits their use in drug discovery. For these and other reasons, it would be useful to develop alternative methods and apparatus for high throughput screening that facilitate measuring the kinase dependent phosphorylation of peptides.

### SUMMARY OF THE INVENTION

The systems and methods of the present invention provide an easy-to-use, rapid system for separating differently charged molecules and quantifying them, and can easily be adapted for use with standard microtiter plate readers and loaders. In general, the systems of the invention comprise a) a sample plate comprising a plurality of substantially tubular sample wells arrayed in the sample plate, and at least one capture matrix, positioned in each of the sample wells proximate the bottom or end of the sample well, which comprises a diffusion-inhibiting material; and b) at least one first electrode in electrical contact with at least one sample well at the bottom end of the sample well, and at least one second electrode in electrical contact with the top end of the sample well, where both electrodes are coupled to a power source. The electrical contacts with the bottom and top ends of the sample well may be made through a conductive fluid.

The diffusion-inhibiting materials used in the capture matrix in the sample wells of the system serves to exclude molecules which have not been selected by electrophoretic separation, and to hold or contain those molecules of interest which have been selected. In this way, the non-selected molecules may be washed out of the wells, and the selected molecules retained for detection. The capture matrices used in the present invention may comprise more than one layer of material, with one layer being a diffusion-inhibiting layer of material, and another layer being a binding layer of material which binds the charged molecule of interest in a covalent or non-covalent manner. Various electrode assemblies are preferred for use in the systems of the invention, including plate electrodes, pin electrodes, and conductive liquid electrodes using gels or other hydrophilic diffusion barrier materials to isolate the conductive liquid from the sample in the sample plate.

In another aspect, the invention also provides methods for separating a charged molecule of interest from a mixture of molecules having different charges in a plurality of samples, and quantifying the amount of the charged molecule of interest in the samples, the method comprising the steps of:
(a) filling the sample wells of a system of the invention with a liquid;
(b) adding a sample containing a mixture of molecules to at least two of the sample wells of the device;
(c) applying an electric field across the sample wells by energizing the electrodes, whereby the charged molecule of interest is transported by the electric field into the capture matrix; and
(d) detecting the amount of the charged molecule of interest captured within the capture matrix.

In preferred embodiments of the invention, the system of the invention is filled with an aqueous buffer for use in the electrophoretic separation. The methods may be used effectively to separate differently charged peptides, such as those formed by enzymatic reactions with peptide substrates which add charged moieties to or remove charged moieties from the peptide. Preferred embodiments of the methods utilize a detectable label on the charged molecule of interest to detect the amount of the charged molecule which is captured within the capture matrix, more preferably a fluorescent label. Suitable detection methods for use in the methods of the invention include fluorometry, colorimetry, luminometry, mass spectrometry, electrochemical detection, and radioactivity detection.

### BRIEF DESCRIPTION OF THE DRAWINGS

FIG. 1: A cross sectional schematic for an embodiment of the invention utilizing a plate electrode for the first electrode, a pin electrode plate for the second electrode, and a sample plate containing a gel capture matrix at the bottoms of the sample wells. This type of device was utilized in the experiments of Example 1. Note that the sample wells are arrayed in a substantially parallel fashion, forming multiple rows of substantially parallel tubes.

FIG. 2: A photograph of the dual-plate electrophoresis device for multi-sample electrophoresis in a 384-well microtiter plate format.

FIG. 3a: A photograph of pre- and post-electrophoresed samples in a gel capture matrix system of the invention, used as described in Example 1.

FIG. 3b: A graph of the fluorescence data pictured in FIG. 3a, as measured on a fluorometer. Columns 7 & 8 are wells that contained buffer, but no peptide.

FIG. 4: A schematic of an alternative second electrode for use in the systems of the invention. In this conductive fluid electrode, a set of pin electrodes is physically isolated from the samples in the sample plate by a hollow support structure containing a conductive fluid (such as Tris-borate buffer), and by a hydrophilic diffusion barrier (filter plugs) which permits the exchange of ions between the conductive fluid and the sample, but which isolates the electrode chamber from the wells containing the molecules to be separated.

FIG. 5a: A graph of fluorescence data obtained by electrophoresing samples with various mole fractions of phosphorylated and unphosphorylated fluorescently labeled Kemptide in the device shown in FIG. 4 for 5 minutes.

FIG. 5b: A graph of fluorescence data obtained by electrophoresing samples with various mole fractions of phosphorylated and unphosphorylated fluorescently labeled Kemptide in the device shown in FIG. 4 for 10 minutes.

FIG. 6: A schematic of an alternative second electrode for use in the systems of the invention. In this conductive fluid electrode, a set plate electrode is physically isolated from the samples in the sample plate by a set of hydrogels held in microcapillary tubes. The gels contain a conductive fluid (such as Tris-borate buffer), and serve as a hydrophilic diffusion barrier which permits the exchange of ions between the conductive fluid and the sample, but which isolates the electrode chamber from the wells containing the molecules to be separated.

FIG. 7: A graph of fluorescence data obtained by electrophoresing samples with various mole fractions of phosphorylated and unphosphorylated fluorescently labeled Kemptide in the device shown in FIG. 6 for 5 minutes.

FIGS. 8a-8d: Graphs showing the effect of various concentrations of salt ions on the ability of the systems of the invention to electrophoretically separate phosphorylated and unphosphorylated Kemptide for fluorescent detection. Note that the systems are effective over a wide salt concentration range. This indicates that electrophoretic separation of products using the systems of the invention is practical in various salt-containing buffers used in kinase, phosphatase, and protease reaction assays, demonstrating the feasibility of single plate reaction and separation of reaction products.

FIG. 9: A graph showing one-plate enzymatic reaction and electrophoretic separation in a system of the invention using the Kemptide/protein kinase A system as a model. As compared to a two-plate (reaction in one microtiter plate, separation in a system of the invention) assay, there is a higher background signal. However, phosphorylated Kemptide is clearly differentiable from unphosphorylated Kemptide, as compared to the passive diffusion data. In addition, the background level appears to be relatively consistent, which indicates that good quantitative results may still be obtained by subtracting out the background.

FIG. 10: A graph showing the electrophoretic separation of several Kemptide samples labeled with different fluorophores. These data demonstrate the compatibility of the systems of the invention with several commonly used fluorescent labels.

### DEFINITIONS

As used herein, “tube” and “tubular” generally refer to any hollow elongated structure with any type of cross sectional shape, including circular, square, triangular, polygonal, ellipsoid, or irregular. Although it is preferred the wall thickness be less than the void in the center of a tubular structure, thick walled tubes are also within the meaning of the term. Tubular structures may be open or closed at either or both ends.

The term “array,” as used herein, means a set of members, specifically tubular sample wells, deliberately arranged in a plane. The regular arrangement may be rectangular, radial, or any other geometrically symmetric shape. Irregular arrays may also be used, although they are not preferred for use in the invention because they are not generally compatible with standard microtiter plate readers and loaders. Although rectangular arrays with 96, 384, or 1536 members are-preferred because of their direct compatibility with standard microtiter plate formats, other specialized rectangular arrays (e.g., 10 by 10) are also envisioned as within the scope of the term. In the sample well arrays of the invention, the sample wells are arranged so that the axes of the sample wells (or length of the tube forming the sample wells) are substantially parallel (or having a greater parallel component than perpendicular component of any angle of deviation).

As used herein, “diffusion-inhibiting material” means a material which under electrophoretic conditions allows the passage through the material of small molecules on the scale of the charged molecule of interest, but which prevents the free diffusion of small molecules on the scale of the charged molecule of interest through the material. Examples of diffusion-inhibiting materials include hydrogels, such as agarose, polyacrylamide, aminopropylmethacrylamide, 3-sulfopropyldimethyl-3-methacrylamidopropylammonium inner salt, methacrylic acid, 3-sulfopropylmethacrylate potassium salt, glycerylmonomethacrylate, and derivatives thereof; sol-gels and silica gels, controlled porosity glass, size-exclusion membranes, chromatography resins, and other suitable materials which slow the diffusion of molecules through the sample well by molecular sieving or other means. One characteristic of the diffusion-inhibiting materials is that they may hold the molecule of interest, and other molecules, in place in the absence of an electric field.

As used herein, “binding layer” or “binding material” refers to materials which have the ability to covalently or non-covalently bind at least one molecule of interest, usually through covalent bonding, hydrogen bonding, ionic bonding, Van de Waals interactions, and other non-covalent chemical interactions. These materials include specific affinity binding materials, such as antibodies, avidin, streptavidin, haptens, biotin, and other specific interaction materials. Binding materials also include non-specific binding materials such as metal chelate resins, anionic resins, and cationic resins, polyvinylidine fluoride, nitrocellulose, and positively charged nylon. Binding materials preferably bind to an unlabeled or affinity-labeled charged molecule of interest with an equilibrium highly biased towards the bound state.

### DETAILED DESCRIPTION OF THE INVENTION

The present invention provides systems and methods as described herein permit simultaneous electrophoretic separation of peptides, and other molecules having different net charges, and the subsequent quantification of those charged molecules. These systems and methods are easily adapted to be compatible with a variety of readily available standard detection equipment, including fluorometric or calorimetric microtiter plate readers. Utilizing non-radioactively labeled substrates, and standard detection systems, the systems of the present invention may easily be used to analyze reaction samples in a highly parallel fashion for high-throughput assays to determine inhibitors or stimulators of kinases, phosphatases, proteases, and other biologically active proteins.

In a general, the apparatus includes a sample plate comprising a plurality of tubular sample wells, where each well contains a capture matrix designed to retain the molecule of interest upon electrophoresis of a sample. The system also contains at least one pair of electrodes. Each discrete sample well is in electrical contact with a first electrode near the bottom of the well, and a second electrode near the top of the well. The capture matrix comprises a diffusion-inhibiting material that retards the free diffusion of molecules. This material serves two functions: first, to ensure that the charged molecules of interest are retained for detection within the capture matrix after electrophoresis; and second, to prevent other molecules from diffusing into the capture matrix. The capture matrix preferably also contains other layers of material which bind the charged molecules of interest. Such a binding layer captures the charged molecule of interest in a specific or non-specific manner in order to hold the charged molecules of interest in a particular location for detection, which allows more facile quantification of the molecule of interest as compared to a diffusion-inhibiting layer only capture matrix. As the binding layer will often also bind other molecules in the sample, the second function of the diffusion-inhibiting material is important in these embodiments.

In the methods of the invention, individual samples, containing molecules of different charges, are loaded into the wells of the sample plate. The samples are then electrophoresed in a liquid which supports the electrophoretic movement of the analytes in the sample, preferably an aqueous buffer. Upon electrophoresis, the charged molecules of interest are selectively transported and concentrated in the capture matrix. The molecules with a negative charge move towards the anode and may be sequestered by a capture matrix placed between the sample and the anode. Alternately, molecules with a positive charge move towards the cathode and may be sequestered by a capture matrix placed between the sample and the cathode. Uncharged molecules, and those of a charge not captured by the capture matrix, are washed out of the sample wells and apparatus with a washing buffer. Alternatively, molecules of an undesired charge are electrophoretically moved into one of the buffer reservoirs of the apparatus, where they may be removed by continuously replenishing the buffer. The molecules of interest which are retained in the capture matrix may then be detected by any appropriate means, including fluorometry, colorimetry, luminometry, mass spectrometry, electrochemical detection, and radioactivity detection. Fluorometric labels and detection are preferred for use in the methods of the present invention because of their ease of use and handling, and the fact that most researchers are familiar with fluorometric detection techniques.

The methods and systems described herein may be used to detect the activity of kinase, protease, or phosphatase enzymes on labeled or unlabeled substrates, and may generally be applied to monitor the chemical modification of a molecule resulting in a product of altered net charge. The system permits simultaneous parallel analysis of many samples by electrophoresing multiple samples at the same time. This is advantageous for the screening of large numbers of compounds for their effects on various kinases, phosphatases, and proteases. In addition, as the capture matrix isolates the whole fraction of charged molecules of interest for detection, the electrophoresis and detection steps may be done sequentially or simultaneously. Traditionally, substrate conversion analysis has been done in agarose or acrylamide slab gels, which utilized the gel matrix to separate modified (altered charge) from unmodified substrates. Although the slab gel technique works well for a few samples, parallel analysis of a large number of samples is not practical. In addition, the intrinsic irregularities of the slab-gel method make it difficult to compare samples run in different gels. Capillary gel electrophoresis devices, such as that described in U.S. Pat. No. 5,916,428, which also separate the charged molecules in a gel matrix, may be used to separate and analyze charged molecules in such samples. However, these devices require somewhat specialized and bulky equipment to load the samples and detect the movement of the labeled substrate through the capillary. Moreover, such devices require dynamic detection during the electrophoresis process. Although such devices in the art are useful for the separation of complex mixtures of molecules in which several species are to be detected, they are usually too costly and cumbersome for use in high-throughput combinatorial library screening applications.

Sample Plate Design and Construction

In a preferred embodiment, the system is comprised of a sample plate containing a plurality of substantially parallel sample wells, which may be arrayed in any configuration permitting simultaneous analysis of multiple samples. For example, standard 96-, 384-, 1536-well microtiter plate formats (8.5×11 cm) may be used, and rectangularly arrayed sample plated are preferred. The sample wells are preferably short, being 0.5 to 3.0 cm, and more preferably 1.0 to 2.0 cm deep, including the capture matrix. The sample plate may be constructed by any usual means, including molding, machining, or laminar construction (which is useful for sandwiching a layer of capture matrix material between two layers of support material which form the sample plate). Suitable materials for construction include polystyrene, polycarbonate, polypropylene and other polymers, as well as glass, quartz, and other silicate materials. Important considerations are that the materials should be insulatory, and should have a low background signal in whatever detection system is to be used with the system (i.e., low fluorescence).

The plurality of sample wells are open at their top and bottom ends, with the capture matrix positioned near one end of the sample well. The capture matrix forms a continuous layer across the sample well, as illustrated in the examples. Usually, a capture matrix will be positioned at or near the bottom of the sample well, near the first electrode. However, alternative embodiments are envisioned in which a second capture matrix is positioned, after the sample is loaded, at or near the top end of the sample well. With this configuration, both a positively and negatively charged molecule of interest could be captured from a sample for detection in the systems of the invention. In the assembled system, each sample well is in contact with a first electrode at its bottom end, and with a second electrode at its top end. The electrode contact may be direct or alternately may be indirect, such as through a conducting medium such as a conductive liquid or buffer.

Capture Matrix Composition

The capture matrix is an integral part of the systems of the invention, in that it has the ability to capture and hold the charged molecules of interest for later or simultaneous detection. In this way, the capture matrix of the present invention differs substantially in function from the gel separation matrices used in slab gel electrophoresis or in capillary gel electrophoresis. In those techniques, the hydrogel is used to separate and define groups of molecules within the gel matrix. As used in the present invention, the capture matrix is merely used to hold and segregate a single group of charged molecules (i.e., all molecules of a certain charge) from the other molecules in solution. Because of this simplified function, the capture matrices used in the present invention have different physical dimensions. In the systems of the present invention, preferred capture matrices have a thickness of less than 0.5 cm along the path of electrophoresis, more preferably a thickness of less than 0.3 cm, more preferably a thickness of less than 0.2 cm, and most preferably a thickness of less than about 0.1 cm.

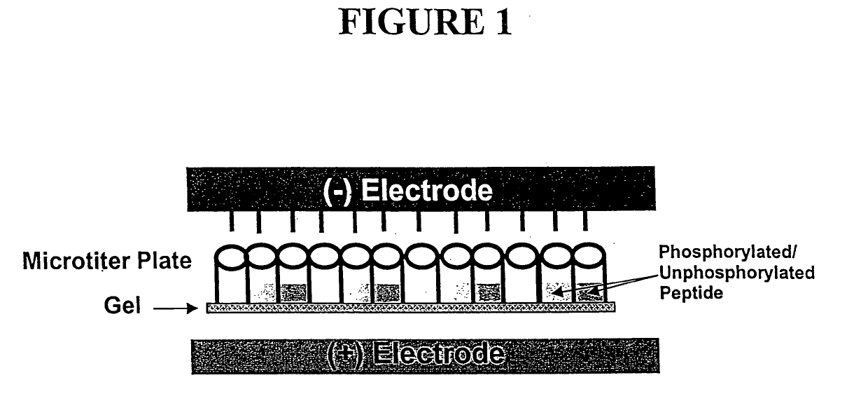

The capture matrix comprises a diffusion inhibiting material which impedes the passive transport of the molecules of interest and the other molecules in the sample. This serves two purposes. First, to separate the molecule of interest upon the application of an electric field across the sample well by selectively electrophoresing the charged molecule of interest into the capture matrix based upon, its charge, as the uncharged and oppositely charged molecules will be prevented from entering the capture matrix by simple diffusion alone. Second, after the sample has been electrophoresed, the diffusion-inhibiting material holds the charged molecule of interest within the capture matrix in the absence of an electric field, preventing their diffusion back into the sample solution. Sol gels, cellulose, glass fiber, nylon, and hydrogels are preferred for use as diffusion-inhibiting materials in the capture matrix. Hydrogels, such as agarose, polyacrylamide, aminopropylmethacrylamide, 3-sulfopropyldimethyl-3-methacrylarnidopropylammonium inner salt, methacrylic acid, 3-sulfopropylmethacrylate potassium salt, glycerylmonomethacrylate, and derivatives thereof, are particularly preferred. The capture matrix may be comprised of a single layer of diffusion-inhibiting material, as in the systems described in FIG. 1 and Example 1. Or the capture matrix may comprise a gradient layer of diffusion-inhibiting material. This gradient may be a density or other physical property gradient, or may be a chemical property gradient.

The diffusion-inhibiting portion of the capture matrix is usually formed by casting a hydrogel in the sample wells or by pressing the sample wells into a sheet of hydrogel. For instance, the sample plate may be prepared by first sealing its bottom surface with a standard microtiter plate sealer (e.g. Dynex Technologies). Once the plate is sealed, a solution of acrylamide or a melted agarose solution is pipetted into the bottom of each sample well. An acceptable agarose solution for use as a diffusion-inhibiting layer comprises 0.08% agarose in 50 mM Tris-Cl at pH 8.0. After placing the agarose solution in the sample plate, it is allowed to cool to room temperature and solidify. The acrylamide solution preferably comprises 20% acrylamide (19:1 acrylamide: bis-acrylamide), 0.5% Darocure 4265 and 50 mM Tris-Cl, at pH 8.0. After pipetting into the sample wells, the acrylamide solution may be polymerized by subjecting the sample plate to ultraviolet irradiation for approximately two minutes in a UV curing light box. The plate sealing film is then removed from the sample plate, and it is ready for use in the methods of the invention. Alternately, a capture matrix may be formed in the bottom of the sample plate using an acrylamide gel sheet. The sample plate is pressed into a gel sheet pre-cast in parallel glass plates using a spacer, which forms a seal between the bottom of the sample wells and the acrylamide gel.

The capture matrix most preferably also comprises a binding layer of a material that binds the charged molecule of interest specifically or non-specifically. Although diffusion-inhibiting -only capture matrices are functional in these embodiments of the invention, it is preferred to use a binding layer to capture the charged molecule of interest in a more precise location. By concentrating the molecule of interest in a binding layer, the signal from the molecule is intensified at that location, facilitating detection and quantification of the molecule of interest. Therefore, it is preferred that the capture matrix comprise a binding layer, which is separated from the sample by the diffusion-inhibiting layer of material. Binding layer materials bind the molecule of interest through covalent or non-covalent bonds. Specific-binding materials for use in a binding layer include antibodies, streptavidin, avidin, biotin, and haptens. The capture matrix may be comprised, for example, of a layer of nonspecific binding material such as metal chelate resins, anionic resins, and cationic resins, polyvinylidine fluoride, nitrocellulose, and positively charged nylon. The binding-layer of the capture matrix is separated from the sample by a layer of diffusion inhibiting material in the capture matrix. This prevents the binding of non-interest molecules to a non-specific binding material, and likewise prevents competitive interference from the sample for specific binding materials.

These types of capture matrices may be constructed, for example, from a sample plate by cutting a sheet of Nylon (+) membrane (Biodyne B membrane, Pall Corp., East Hills, N.Y.) to fit the bottom of the sample plate. The plate and the membrane are then clamped together. Alternatively, filter membrane ready microtiter plates may be used, as described in Examples 2 and 3. A melted agarose solution (preferably 0.8% in 50 mM Tris HCl at pH 8.0) is then pipetted into each sample well. The agarose is then allowed to cool, after which the membrane becomes attached to the plate by the solidified agarose. Alternatively, a similar amount of unpolymerized acrylamide/bis-acrylamide solution may be pipetted over the membrane, and cured in a UV light box. The sample plate is then ready for use in the methods of the invention.

Electrode Design

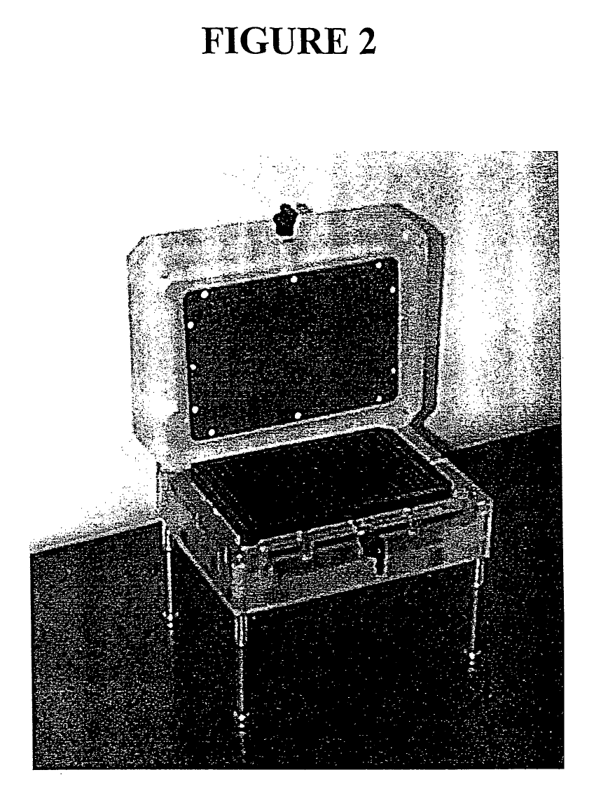

The electrodes may be wires, strips, flat plates, or other convenient shapes, and may be soldered, deposited, etched, or glued in place with epoxy. Electrodes may be made of any suitable conductive material, including platinum and platinum plated-titanium, gold, carbon fibers, and conductive polymers. Although non-corroding materials are preferred for use in reusable embodiments of the invention, reactive metals such as aluminum, copper, or steel may be used in limited-use devices. The electrodes are electrically connected to a controlled power source (e.g., constant current or voltage). If a plurality of first and second electrodes are used, the electrodes may be controlled individually (to control electrophoresis at individual sample wells) or in tandem (i.e., controlling multiple positive electrodes together and controlling multiple negative electrodes together). The electrical contact may be direct, or may occur through a conducting medium (e.g., a glass capillary filled with a conductive-buffer-containing hydrogel). In one preferred embodiment, the electrode assembly comprises a first and a second flat plate electrode, as pictured in FIG. 2. Alternately, the electrode assembly may comprise of a first flat plate [lower] electrode and at least one individual pin electrode, which is in electrical contact with a sample well.

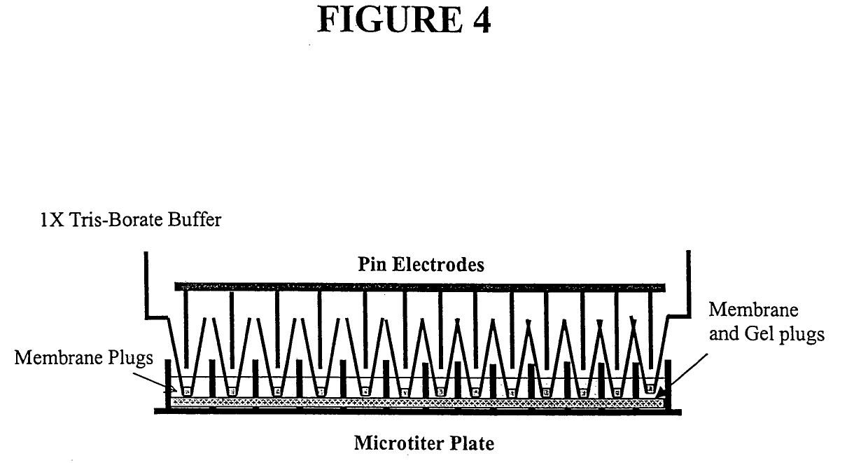

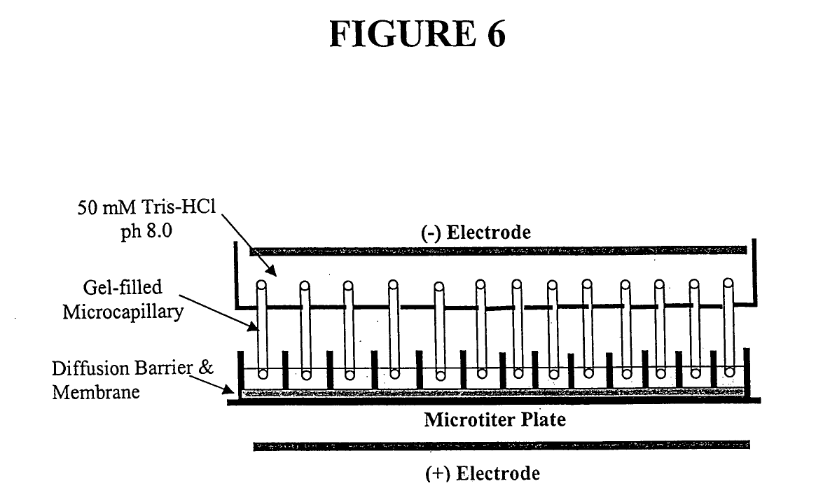

Conductive-liquid-containing electrodes are also preferred electrodes for use in the systems of the invention. For instance, the second electrode may comprise an array of conductive fluid members in electrical contact with at least one electrode, where each conductive member of the array is in contact with a sample well. A conductive fluid member may be a conductive buffer containing hydrogel fluid contained within a solid tubular support, as depicted in FIG. 6. Or, the conductive fluid member may be a hollow solid support (tubular, conic, or any other convenient shape) containing a conductive fluid, where the conductive fluid is separated from the sample of a sample well in the sample plate by a hydrophilic diffusion barrier, as illustrated in FIG. 4. Suitable hydrophilic diffusion barriers for use in hollow conductive fluid electrodes include all the aforementioned diffusion-inhibiting materials, although porous glass is preferred. Alternatively, in wholly disposable multiple- or single-use devices, the electrodes may be integrally formed with the microstructure plate (e.g., by placing the electrodes within the layer of the microstructure plate before polymerization, or between laminar layers of the sample plate).

### GENERAL METHODS OF THE INVENTION

In general, a sample plate is prepared by placing the plate into a electrophoretic liquid (usually aqueous buffer) reservoir in electrical contact with a first electrode. Then, a sample comprising positively and negatively charged peptides, or other molecules of interest, is pipetted into the sample plate. The-second electrode is placed into contact with the sample wells, and the electrodes are energized for the electrophoresis step. After the molecule of interest has been captured in the capture matrix, the captured molecules are detected.

In preferred embodiments of the methods of the invention, an aqueous buffer is utilized as the liquid in the system. Suitable buffers for use in the electrophoretic methods of the invention include Tris hydrochloride buffers, Tris borate buffers, histidine buffer, β-alanine buffers, adipic dihydrazide buffers, and HEPES (N-[2-Hydroxyethyl]piperazine-N′-[2-ethanesulfonic acid]) buffers. Alternatively, an organic or other non-buffering liquid, such as DMSO, may be used. When the systems and method of the invention are used to analyze the action of an enzyme upon a labeled substrate (e.g., kinase, phosphatase, or protease reaction assays), the enzyme buffer may be used. This has the advantage of allowing one to carry out the reaction in the sample well and then immediately electrophoresing the products of the reaction for detection. As shown in Example 4, the systems and methods of the invention are compatible with a wide range of biologically relevant salt concentrations. Example 5 demonstrates the ability of the systems of the invention to be used as a one-plate incubation and electrophoretic separation device in a protein kinase A assay.

After the samples have been placed into the sample wells of the sample plate, and the electrodes are in place, the electrodes are energized to create an electric field across the sample wells. The current, voltage and time depend upon such factors as capture-matrix composition and buffer composition, and the total electromotive force necessary to move a particular charged substrate or product through the solution in a reasonable time frame. These factors are well known in the art, and persons skilled in the electrophoretic arts can ascertain, with a minimum of experimentation, the optimal voltage, amperage, and time to use with the devices of the invention in particular applications. In general, useful voltages range between 1V to 1000V, more preferably between 10V to 500V, and most preferably 30V to 200V. Useful amperages range from 1 mAmp to 10000 mAmp, preferably 100 mAmp to 5000 mAmp, and most preferably 500 mAmp to 2000 mAmp per sample well.

Any suitable means for detection may be used in the methods of the invention, including fluorometry, colorimetry, luminometry, mass spectrometry, electrochemical detection, and radioactivity detection. Fluorometry is preferred for use in the present invention, because of the ease handling fluorophores, and the commercial availability of fluorescent microtiter plate readers. Fluorescently labeled peptides for use in kinase, phosphatase, or protease reactions may be made by derivatization with a fluorescent moiety, as has been described in the relevant assay literature. An advantage of the systems and methods of the invention is that the electrophoretic process and the detection process may be separated in time. Where a capture matrix with a binding layer is utilized, the detection process may be carried out from several minutes up to one hour after electrophoresis. However, if a only a diffusion-inhibiting material is utilized in the capture matrix, detection should take place promptly after electrophoresis in order to avoid diffusion of the charged molecule of interest.

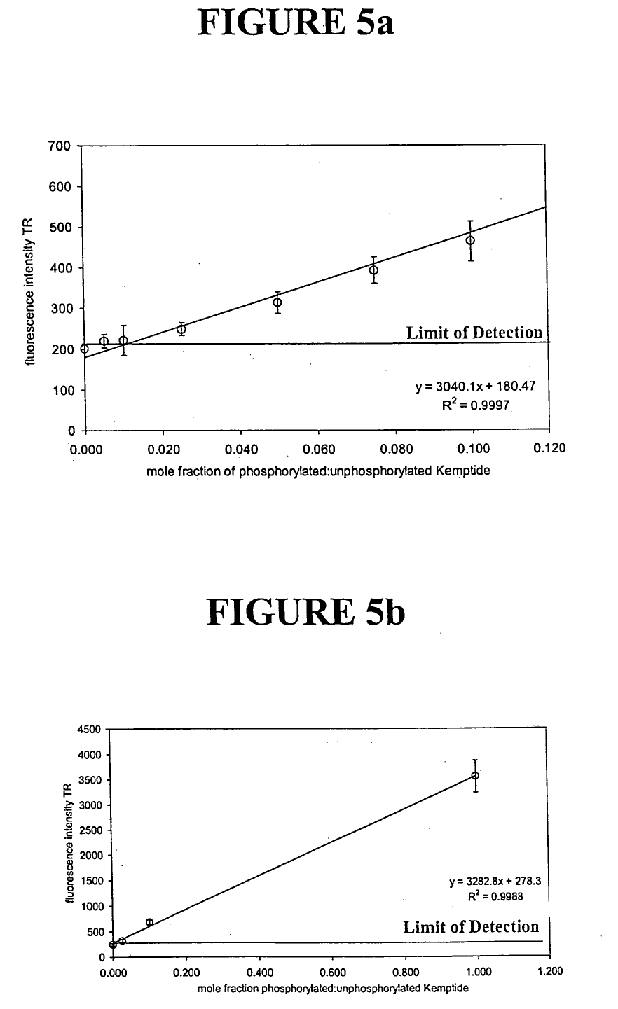

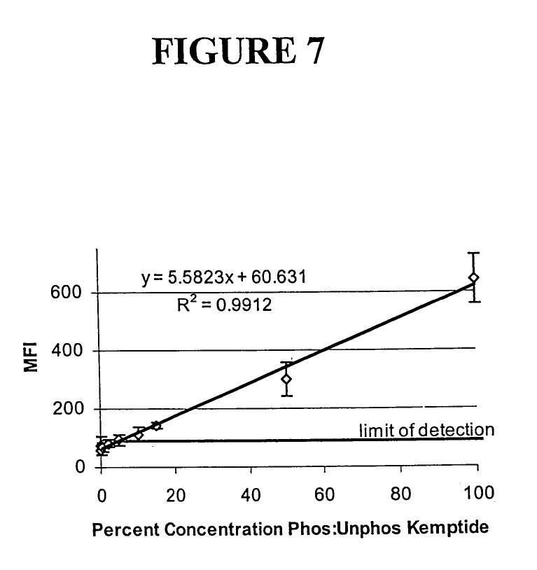

Utilizing these methods, very good sensitivity has been obtained in detecting the enzymatic conversion of substrates (e.g., kinase or phosphatase phosphorylation/dephosphorylation, or protease-reactions). The systems and methods of the invention are able to detect about 10%, more preferably about 1.0%, and most preferably about 0.1% conversion of a labeled substrate in enzymatic reactions. Examples 2 and 3, and FIGS. 5a, 5b and 7, show the sensitivity of detection obtained by the systems and methods of the invention, utilizing conductive fluid electrodes. The high sensitivity and convenient format of these systems make them ideal for use in high-throughput drug screening applications.

### EXAMPLES

The following examples are offered to further illustrate the various aspects of the present invention, and are not meant to limit the invention in any fashion. Based on these examples, and the preceding discussion of the embodiments and uses of the invention, several variations of the invention will become apparent to one of ordinary skill in the art. Such self-evident alterations are also considered to be within the scope of the present invention.

### Example 1

### Illustrative Assay for Protein Kinase A Phosphorylation of Substrate Peptide in an Azarose- or Acrylamide-Filled Electrophoresis Sample Plate

Reagents:
20 mM Tris-HCl pH 8.0
10 mM MgCl₂
1 mM ATP
1 μM cAMP
60 μM Kemptide
350 mM K₃PO₄ pH 7.5
0.1 mM DTT
0.8% agarose gels in 50 mM Tris-HCl, pH 8.0 or
8%, and 20% acrylamide gels (19:1 Acrylamide:Bis-acrylamide), with 0.5% Darocure 4265

Agarose- or acrylamide-filled electrophoresis sample plates were prepared by the following methods: Sample plates of microtiter wells open on both ends were sealed on the bottom end with a Dynex Technologies plate sealer. 0.8% agarose in 50 nM Tris-Cl pH 8.0 was melted to a fluid consistency. While hot, the agarose was pipetted into the bottom of each well of the sealed sample plate. 96-well sample plates were filled with 100 μl agarose and 384-well sample plates were filled with 301 μl per well. After about 20 minutes, when the agarose had cooled and solidified, the plate sealing film was removed and the sample loaded for electrophoresis as set forth below. Alternatively, the sample wells were filled with a similar same amount of unpolymerized acrylamide solution, and then polymerized under UV light for 2 minutes.

The kinase reaction was performed by mixing 20 mM Tris-HCl pH 8.0, 10 mM MgCl₂, 1 mM ATP, 1 μM cAMP, 60 μM of fluorescently-labeled Kemptide, 350 mM K₃PO₄ pH 7.5, 0.1 mM DTT, with or without 0.8 μg/ml PKA in 30° C. for 30 min. After phosphorylation by protein kinase A, Kemptide the peptide bears a net negative charge. For phosphorylated peptides, sufficient protein kinase A was added to the reaction to phosphorylate all of the substrate peptide (0.8 μg PKA/ml reaction mixture). For unphosphorylated peptide, no PKA was added to the reaction mixture.

Electrophoresis of the sample was performed using the apparatus and setup depicted in FIGS. 1 and 2. Electrophoresis was accomplished by placing a sample plate into a buffer reservoir of 50 mM Tris-Cl, pH 8.0 in the device pictured in FIG. 2. The chamber was filled with enough buffer to ensure fluid contact between each of the wells and the electrode, but below the top of the sample plate. Each of the wells of the plate was filled completely with the same buffer. Samples of peptides (10 μM), were loaded into individual wells (201 μl/well) for electrophoresis. Another platinum-coated titanium pin electrode plate was placed on the microtiter plate so than electrical contact was made between the pins and the liquid in the sample wells.

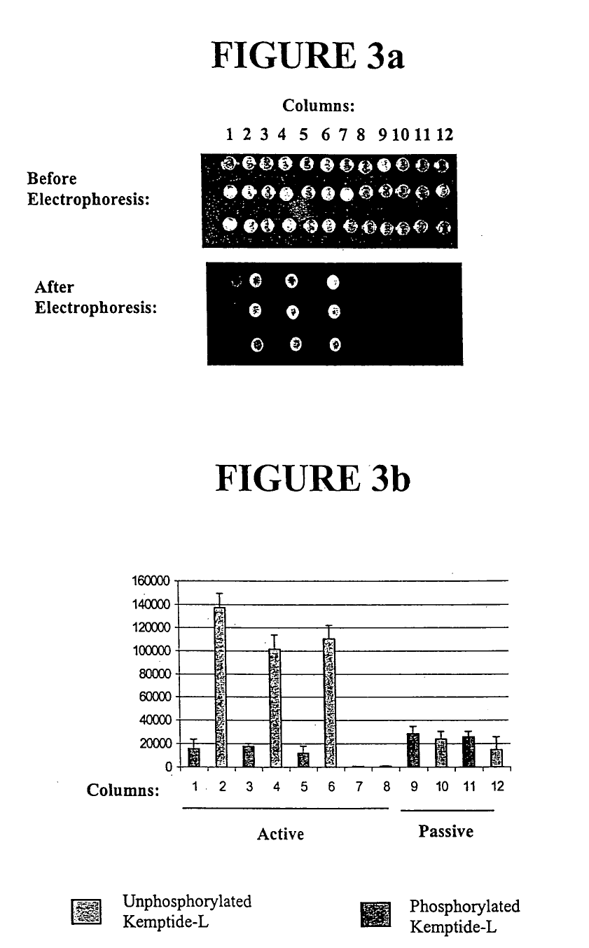

The samples were then electrophoresed at 4V for 14 minutes. The plate electrode placed beneath the microtiter plate was positively biased (anode) and the upper pin electrode plate was negatively biased (cathode). After electrophoresis by either method, the sample plate was removed from the electrodes, the wells of the plate washed with buffer, and the fluorescence was visualized on a UV light box with CCD camera (results pictured in FIG. 3a,) and relative fluorescence intensities were read with a Molecular Dynamics (Biolumin 960) plate reader (results pictured in FIG. 3b). As shown, fluorescence was recorded in wells that contained negatively charged peptides (phosphorylated substrate peptide), but none was visible in wells that had contained positively charged peptides (unphosphorylated peptide).

### Example 2

### Illustrative Assay For Protein Kinase A Phosphorylation of Substrate Peptide in a Gel/Membrane Sample Plate with Conductive Liquid Electrodes

Acrylamide/membrane sample plates were prepared from 384-well plates (produced by Greiner) with Biodyne B membrane (from Pall, Inc.) on the bottom of the wells. 15 μl of 20% acrylamide was pipetted into each well and UV cured, as described above, to form a diffusion-inhibiting layer.

Samples of phosphorylated and unphosphorylated Texas Red labeled Kemptide were then prepared as described above in Example 1. Samples of charged peptides (20 μl of 10 μM, or 50 mmol peptide) were diluted into 1× Tris-borate buffer (pH8.0) and applied into the wells of the 384 well sample plate.

Conductive-liquid second electrodes, as shown in FIG. 4, were used. The top electrode reservoir was filled with the Tris-borate buffer or 50 mM Tris-HCl. Electrophoresis was carried out for 5 minutes at 100 mAmp. The wells were then washed and read using the SpetroFluor Plus microtiter plate reader. The graph in FIG. 5a shows the fluorescent intensities read by the plate reader versus the mole fraction of phosphorylated Kemptide in solution of unphosphorylated Kemptide.

As shown, the detection is linear in the 0.5%-10% conversion range that is desired for high-throughput screening at total peptide concentration of 0.75 μM. Also, the results were fairly reproducible with % coefficients of variation lower than 10% over eight replicates. The minimal detectable concentration was 1.2% phosphorylated Kemptide in 98.8% unphosphorylated Kemptide. To improve the minimal detectable concentration, we tried lengthening the electrophoresis time to 10 minutes. The graph in FIG. 5b depicts similar results with longer electrophoresis time, with a full peptide conversion data point for comparison. The minimal detectable signal was reduced to 0.5% phosphorylated Kemptide in 99.5% unphosphorylated Kemptide.

### Example 3

Electrophoresis in 1536-well Sample Plates Using Gel-Capillary Electrodes Reaction plates for this device were made by Greiner with a Biodyne B membrane coating the bottom of the plate. A 3 μl layer of 20% acrylamide served as a diffusion-inhibiting layer at the bottom of each well. A gel-capillary upper structure was designed to allow current to pass through to the wells while segregating the electrochemistry at the cathode from the reaction mixture, as shown in FIG. 6.

For effective electrophoresis, the microcapillaries were filled with a gel that has low resistance and also prevents the buffer bath from leaking into the reaction plate. We tested agarose gels with concentrations ranging from 0.3 to 1.0%. These gels had low resistance, with currents of 0.3 to 0.6 mAmps/well. To make more robust gels, agarose was chemically crosslinked to the interior surface of the glass microcapillary. A solution of 1% N-(2-aminoethyl)-3-aminopropyl-trimethoxysilane (AEAPS) was prepared in 95% ethanol. Plasma-cleaned microcapillaries were immersed in the solution for one hour. The glass was then rinsed twice with ethanol and cured at 90° C. for one hour. Meanwhile, a 1% glyoxal agarose slurry was heated to 100° C. for 9 minutes. NaCNBH₃ was added to 50 mM and the warm agarose was immediately used to fill the silylated glass microcapillaries.

The ability of the functionalized agarose gel-capillary electrode system to discriminate phosphorylated from unphosphorylated peptide was examined. Mixtures of phosphorylated and unphosphorylated Texas Red-labeled Kemptide were prepared to simulate the products of an inhibited enzymatic reaction, as described above. Each mixture had a total peptide concentration of 1 μM with 0 to 100% phosphorylated Kemptide. A reaction plate was prepared with 7 μl per well of peptide mixture. The upper gel-capillary structure was lowered into the wells and electrophoresis was performed for 5 min at 110 V. Adjacent wells containing the peptide mixture did not have the potential applied and were passive diffusion controls. Peptide solutions were aspirated from the wells before the plate was analyzed by the Tecan SpectraFluor Plus plate reader (excitation: 590 nm, emission: 635 nm). Mean fluorescence intensities are shown in the graph in FIG. 7. These results show that discrimination can be achieved at 5% conversion of the peptide.

### Example 4

### Effect of Ionic Concentrations on the Electronic Kinase Assay

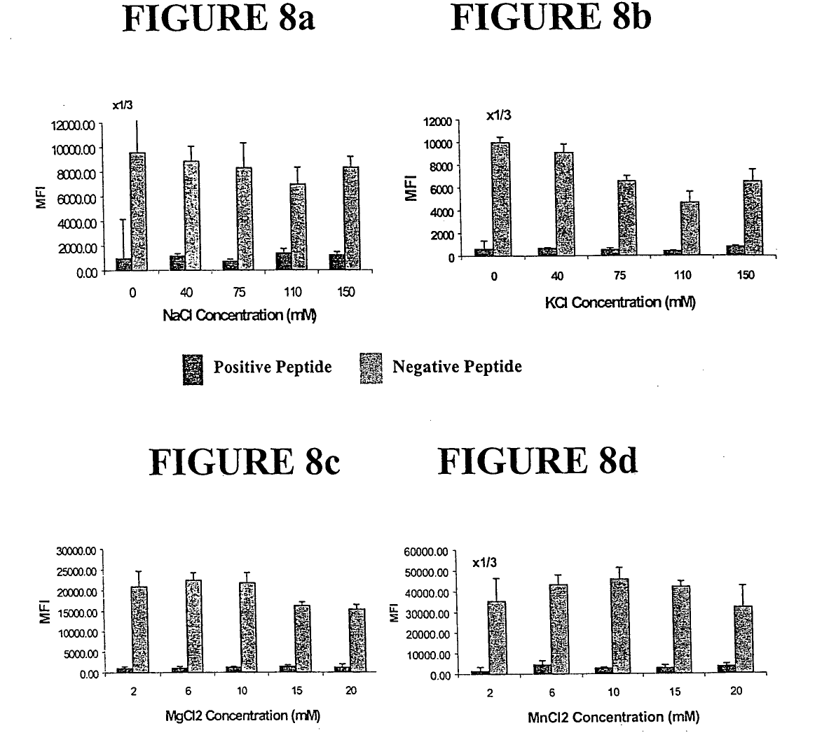

The effects of particular counter-ions in the buffer on the separation of phosphorylated and unphosphorylated Kemptide was explored. The following ions/concentrations were tested in bottomless 96-well microtiter plates plugged with 20% acrylamide gel, prepared as described in Example 1: NaCl 0-150 mM, KCl 0-150 mM, MgCl₂ 2-20 mM, and MnCl₂ 2-20 mM. The electrophoresis time was 1 minute at ramped voltages of 0-60V, corresponding to an average voltage of 30V. The bar graphs in FIGS. 8a-d depict fluorescent intensities obtained for the above ions from the Molecular Dynamics (Biolumin 960) plate reader. The results show that the phosphorylated and unphosphorylated Kemptide can be separated by electrophoresis in the specified ionic ranges, which are useful in activity assays for various kinases.

### Example 5

### Kinase Assay and Electronic Separation in One Plate

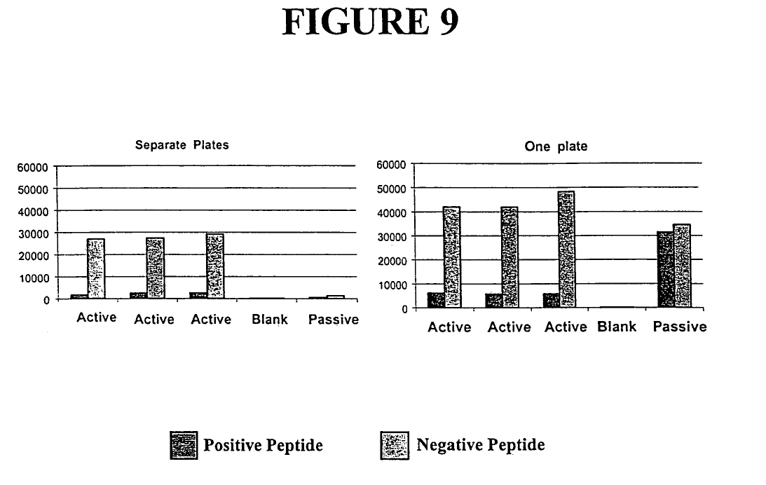

In order to reduce cost and complexity, it is desirable to perform both the kinase assay and peptide separation in one sample plate. In this example, the kinase reactions were performed in each well of bottomless 96-well microtiter plates plugged with 20% acrylamide gel. After the reaction was complete, the peptides were diluted to 15 μM with 50 mM Tris-HCl pH 8.0. Electrophoresis was carried out for 1 minute at ramping voltages of 0-60 V. The bar graphs in FIG. 9 depict fluorescent intensities obtained from the Molecular Dynamics (Biolumin 960) plate reader. These results show that there is a general increase in signal for both phosphorylated and unphosphorylated Kemptide when the kinase assay is performed in the same plate. However, the ratio of phosphorylated over unphosphorylated peptide remains the same. It is noticeable that signals from passive diffusion for both types of peptides are much higher when the kinase assay is performed in the same plate. This is due to the extra 30-minute incubation time for the kinase reaction.

### Example 6

### Use of Various Labeled Peptides in Microtiter Plate Electrophoresis

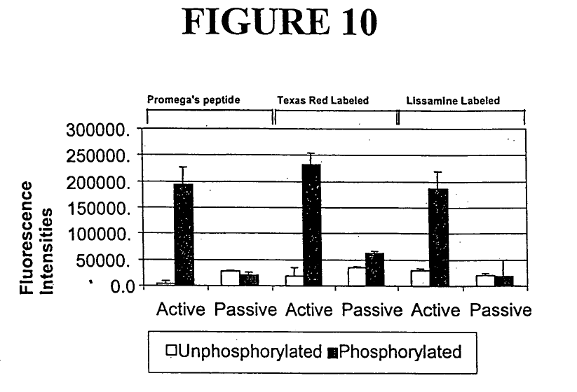

In this example various fluorophore-labeled peptides were electrophoresed in 96-well agarose gel capture matrix sample plates, as described above. In order to compare the relative kinase reactivities of the various labeled peptides, Lissamine, Texas Red, and Promega Kemptide were diluted individually into kinase reaction buffer. The peptides were then phosphorylated to completion by the addition of protein kinase A, or left unphosphorylated for subsequent analysis by plate electrophoresis. The kinase reaction solutions were layered into the wells of bottomless agarose gel sample plates and electrophoresed. The bar graph in FIG. 10 depicts fluorescent intensities obtained from the Molecular Dynamics (Biolumin 960) plate reader. These results show that electrophoresis, rather than passive diffusion, was effective in separating the phosphorylated and unphosphorylated peptide for all three materials. This demonstrates feasibility of making various fluorophore-labeled peptides which serve as substrates for protein kinase A and which can be separated by electric fields from unphosphorylated starting material, utilizing the devices of the invention.

1. A system for separating sample molecules having different charges in a plurality of samples, comprising:
a sample plate comprising a plurality of substantially tubular sample wells arrayed in the sample plate;
at least one capture matrix, wherein the capture matrix is disposed in each of the sample wells proximate an end of the sample wells, and wherein the capture matrix comprises a diffusion-inhibiting material;
at least one first electrode in electrical contact with at least one sample well at the bottom end of the sample well, and at least one second electrode in electrical contact with the top end of the sample well, wherein both electrodes are coupled to a power source.

2. The system of claim 1 wherein the sample plate is a rectangular plate measuring 8.5 cm by 11 cm.

3. The system of claim 2 wherein sample plate comprises 96 evenly spaced sample wells.

4. The system of claim 2 wherein sample plate comprises 384 evenly spaced sample wells.

5. The system of claim 2 wherein sample plate comprises 1536 evenly spaced sample wells.

6. The system of claim 1 wherein the first electrode is a flat plate electrode.

7. The system of claim 1 wherein the second electrode comprises an array of pin electrodes.

8. The system of claim 1 wherein the second electrode is a flat plate electrode.

9. The system of claim 1 wherein the second electrode comprises an array of conductive fluid members in electrical contact with at least one electrode.

10. The system of claim 9 wherein the conductive fluid member is a hydrogel comprising a conductive fluid contained within a solid tubular support.

11. The system of claim 9 wherein the conductive fluid member is a hollow solid support containing a conductive fluid, wherein the conductive fluid is separated from the sample of a sample well in the sample plate by a hydrophilic diffusion barrier.

12. The system of claim 11 wherein the hydrophilic diffusion barrier consists of porous glass.

13. The system of claim 11 wherein the hydrophilic diffusion barrier consists of a paper filter.

14. The apparatus of claim 1 wherein the first electrode is integrated into the material of the sample plate.

15. The apparatus of claim 1 wherein the second electrode is integrated into the material of the sample plate.

16. The system of claim 1 wherein the capture matrix further comprises at least two layers of material, wherein the layers comprise at least one diffusion-inhibiting layer consisting of a diffusion-inhibiting material and at least one binding layer comprising a material having the ability to covalently or non-covalently bind at least one molecule of interest, wherein the binding layer is disposed between the diffusion-inhibiting layer and one electrode.

17. The system of claim 16 wherein the binding layer binds the molecule of interest specifically.

18. The system of claim 17 wherein the binding layer comprises an affinity-binding material selected from the group consisting of antibodies, streptavidin and avidin.

19. The system of claim 18 wherein the binding layer binds the molecule of interest non-specifically.

20. The system of claim 19 wherein the binding layer comprises a material selected from the group consisting of metal chelate resins, anionic resins, and cationic resins, polyvinylidine fluoride, nitrocellulose, positively charged nylon, and porous glass.

21. The system of claim 16 wherein the diffusion-inhibiting layer comprises a material selected from the group consisting of cellulose, glass fiber, nylon, porous glass, and hydrogels.

22. The system of claim 21 wherein the capture matrix comprises a hydrogel selected from the group consisting of agarose, polyacrylamide, aminopropylmethacrylamide, 3-sulfopropyldimethyl-3-methacrylamidopropylammonium inner salt, methacrylic acid, 3-sulfopropylmethacrylate potassium salt, glycerylmonomethacrylate, and derivatives thereof.

23. The system of claim 1, wherein the diffusion-inhibiting material is a hydrogel.

24. The system of claim 23 wherein the capture matrix comprises a hydrogel selected from the group consisting of agarose, polyacrylamide, aminopropylmethacrylamide, 3-sulfopropyldimethyl-3-methacrylamidopropylammonium inner salt, methacrylic acid, 3-sulfopropylmethacrylate potassium salt, glycerylmonomethacrylate, and derivatives thereof.

25. The system of claim 1 wherein the diffusion-inhibiting material is a gradient material, wherein a property of the diffusion-inhibiting material varies from the top of the diffusion inhibiting material to the bottom.

26. The system of claim 25 wherein the gradient exhibits a density gradient.

27. The system of claim 25 wherein the gradient exhibits a chemical property gradient.

28. The system of claim 1 wherein the thickness of the capture matrix along the axis of the tubular sample well is less than 0.5 cm.

29. The system of claim 1 wherein the thickness of the capture matrix along the axis of the tubular sample well is less than 0.2 cm.

30. The system of claim 1 wherein the thickness of the capture matrix along the axis of the tubular sample well is less than 0.1 cm.

31. The system of claim 1 wherein the sample plate comprises a plurality of layers of support material, the support material layers comprising a plurality of voids which align to form the plurality of sample wells.

32. The system of claim 31 wherein the capture matrix is a layer of material sandwiched between two support material layers.

33. A method for separating a charged molecule of interest from a mixture of molecules having different charges in a plurality of samples, and quantifying the amount of the charged molecule of interest in the samples, the method comprising the steps of:
(a) dispensing a liquid into the sample wells of the system of claim 1;
(b) adding a sample containing a mixture of molecules to at least two of the sample wells of the device;
(c) applying an electric field across the sample wells by energizing the electrodes, whereby the charged molecule of interest is transported by the electric field into the capture matrix; and
(d) detecting the amount of the charged molecule of interest captured within the capture matrix.

34. The method of claim 33 wherein the liquid is an aqueous buffer.

35. The method of claim 34 wherein the aqueous buffer is selected from the group consisting of: Tris hydrochloride buffers, Tris borate buffers, histidine buffer, β-alanine buffers, adipic dihydrazide buffers, and HEPES (N-[2-Hydroxyethyl]piperazine-N′-[2-ethanesulfonic acid]) buffers.

36. The method of claim 33 the method further comprising the step of bringing the first and second electrodes of the system into electrical contact with the bottom and top ends of the sample wells.

37. The method of claim 36 wherein the first electrode is a flat plate electrode.

38. The method of claim 36 wherein the second electrode is an array of pin electrodes.

39. The method of claim 36 wherein the second electrode is a second flat plate electrode.

40. The method of claim 33 wherein the second electrode comprises and array of conductive fluid members in electrical contact with at least one electrode.

41. The method of claim 40 wherein the conductive fluid member is a hydrogel comprising a conductive fluid contained within a solid tubular support.

42. The method of claim 40 wherein the conductive fluid member is a hollow solid support containing a conductive fluid, wherein the conductive fluid is separated from the sample in a sample well in the sample plate by a hydrophilic diffusion barrier.

43. The method of claim 42 wherein the hydrophilic diffusion barrier consists of a paper filter.

44. The method of claim 42 wherein the hydrophilic diffusion barrier consists of porous glass.

45. The method of claim 33 wherein the molecule of interest has a negative charge, the first electrode is biased with a positive charge, and the second electrode is biased with a negative charge.

46. The method of claim 33 wherein the molecule of interest has a positive charge, the first electrode is biased with a negative charge, and the second electrode is biased with a positive charge.

47. The method of claim 33 wherein the detection is by a method selected from the group consisting of fluorometry, colorimetry, luminometry, mass spectrometry, electrochemical detection, and radioactivity detection.

48. The method of claim 33 wherein the detection step is carried out by placing the sample plate in a microtiter plate reader.

49. The method of claim 33 wherein the sample is added to the sample wells by an automated microtiter plate sample transfer device.

50. The method of claim 33 wherein an electric current in the range of 1 mAmp to 100,000 mAmp per well is applied across the sample plate to generate the electric field.

51. The method of claim 33 wherein an electric current in the range of 100 mAmp to 5000 mAmp per well is applied across the sample plate to generate the electric field.

52. The method of claim 33 wherein an electric current in the range of 500 mAmp to 2000 mAmp per well is applied across the sample plate to generate the electric field.

53. The method of claim 33 wherein an electric potential in the range of 1V to 1000V is applied across the sample plate to generate the electric field.

54. The method of claim 33 wherein 10V to 500V is applied across the sample plate to generate the electric field.

55. The method of claim 33 wherein an electric potential in the range of 30V to 200V is applied across the sample plate to generate the electric field useful voltages, more preferably between, and most preferably.

56. The method of claim 33 wherein the sample comprises a mixture of peptides, and the charged molecule of interest is a peptide.

57. The method of claim 56 wherein the peptide of interest comprises a detectable label.

58. The method of claim 33 wherein the charged molecule of interest is the product of a substrate reaction wherein the net charge of a substrate is changed in the enzymatic reaction.

59. The method of claim 57 wherein the charged molecule of interest and the substrate both comprise a detectable labeling moiety.

60. The method of claim 59 wherein the labeling moiety is a fluorescent moiety.

61. The method of claim 57 wherein the method is capable of detecting the enzymatic conversion of at least 10% of the substrate.

62. The method of claim 57 wherein the method is capable of detecting the enzymatic conversion of at least 1.0% of the substrate.

63. The method of claim 57 wherein the method is capable of detecting the enzymatic conversion of at least 0.1% of the substrate.
